(19) United States
(12) Patent Application Publication
(10) Pub. No.: US 2008/0300980 A1
(43) Pub. Date: Dec. 4, 2008

(54) Method and system of synchronizing data processed through web widgets distributed across network nodes

(75) Inventors: Yobie Benjamin, Fremont, CA (US); Jonathan Wood, San Francisco, CA (US)

Correspondence Address: Raj Abhyanker, LLP;c/o Intellevate, P.O. Box 52050, Minneapolis, MN, 55402, US

(73) Assignee: Goodstorm, Inc.

(21) Appl. No.: 11/809,833

(22) Filed: May 31, 2007

(51) Int. Cl. G06Q 30/00

(52) U.S. Cl. 705/14; 705/27

(57) ABSTRACT

A method and system of synchronizing data processed through web widgets distributed across network nodes is disclosed. In one embodiment, a method of a service provider module includes linking an admired party webpage of an admired party with a follower webpage of a follower of the admired party when a replica of a web widget of the admired party webpage is integrated to the follower webpage, assigning a common module identification to the web widget of the admired party webpage and to the replica of the web widget on the follower webpage, and simultaneously updating the admired party webpage and the follower webpage using the common module identification based on data processed in at least one of the web widget of the admired party webpage and the replica of the web widget on the follower webpage.

### CLAIM OF PRIORITY

This application claims priority form the non-provisional application Ser. No. 11/448,219 titled “Charisma Monetization Through an Integrated and Reusable Commerce Engine” filed on Jun. 7, 2006

### FIELD OF TECHNOLOGY

This disclosure relates generally to the technical fields of software and/or hardware technology and, in one example embodiment, to a method and system of synchronizing data processed through web widgets distributed across network nodes.

### BACKGROUND

A web widget (e.g., a gadget, a badge, a module, a capsule, a snippet, a mini, and/or a flake) may be a portable chunk of code (e.g., based on Adobe Flash®, JavaScript®, etc.) that can be installed and executed within any separate HTML-based web page by a user without requiring additional compilation. The web widget may be used as plug-ins or extensions in desktop applications.

The web widget modified (e.g., or created) by a publisher (e.g., an admired party of the followers) may be adopted by one or more followers of the publisher. When the web widget is imported to webpages of the followers, data processed through one or more of the webpages of the followers may not be communicated (e.g., reported) to the publisher. As a result, the publisher may not be able to obtain the latest update of transactions (e.g., financial and/or non-financial).

In addition, the publisher may not be able to learn aggregated opinions (e.g., responses) of the followers on agenda advanced by the publisher (e.g., an idea, a survey, etc.). This may prevent the publisher from getting touch with the followers (e.g., who may be patrons of the publisher because the followers emphasize with the publisher based on the publisher's values, beliefs, agenda, etc.) on matters which concern them the most.

### SUMMARY

A method and system of synchronizing data processed through web widgets distributed across network nodes is disclosed. In one aspect a method of a service provider module includes linking an admired party webpage of an admired party with a follower webpage of a follower of the admired party when a replica of a web widget (e.g., the web widget may include a product widget, a media widget, and/or an idea widget) of the admired party webpage is integrated (e.g., the follower may purchase an offering of the web widget of the admired party webpage and the replica of the web widget on the follower webpage based on an empathy relationship between the admired party and the follower formed by a charismatic influence of the admired party on the follower) to the follower webpage, assigning a common module identification to the web widget of the admired party webpage and to the replica of the web widget on the follower webpage, and simultaneously updating (e.g., may be performed through an asynchronous communication and a synchronous communication among the service provider module, the admired party webpage, and the follower webpage) the admired party webpage and the follower webpage using the common module identification based on data processed in the web widget of the admired party webpage and the replica of the web widget on the follower webpage.

The method may also include forming a social network between the admired party and the follower of the admired party based on an invitation data generated by the admired party webpage and/or the follower webpage. The method may further include rendering an individual blog to comment on the product widget, the media widget and the idea widget (e.g., the admired party may solicit information from the follower in context of the product widget, the media widget and/or the idea widget). Moreover, the method may include enabling the follower to rate any item (e.g., a result of the rate any item may be centrally aggregated to render to the admired party webpage) on the web widget of the admired party webpage.

The method may include embedding a promotional graphic data and a really simple syndication (RSS) feed to the web widget (e.g., the promotional graphic data and/or the RSS feed may be placed to a foreground and a background of the web widget) when the promotional graphic data and the RSS feed is thematically relevant to the web widget. The method may further include aggregating individual transactions of the follower across the web widget of the admired party and/or the replica web widget on the follower webpage to enable the follower to checkout at any point in time when the follower is logged on with the service provider module. The method may also include rendering advertisement data to the admired party webpage and/or the follower webpage. Moreover, the method may include enabling the admired party to render the advertisement data to the follower webpage.

In another aspect a method of an admired party module includes installing a web widget to an admired party webpage of an admired party through integrating a code of the web widget to the admired party webpage of the admired party linking the web widget of the admired party webpage with a replica of the web widget of the admired party webpage imported to a follower webpage of a follower (e.g., the follower may import the replica of the web widget of the admired party webpage to the follower webpage to patronize the admired party) of the admired party, and globally updating the web widget of the admired party webpage and the replica of the web widget on the follower webpage based on transaction data of the web widget of the admired party webpage and the follower webpage.

The web widget of the admired party webpage and the replica of the web widget of the admired party webpage on the follower webpage may include a product widget (e.g., the product widget may include offering of T-shirts, CDs, DVDs, video games, and/or classified listings), a media widget (e.g., the media widget may include offering of streaming audios, photographs, and/or streaming videos), and/or an idea widget (e.g., the idea widget may include questions, surveys, proposals, theses, and/or campaigns). The method may further include assigning the follower to a secondary status as the admired party when a web widget created by the follower is imported to a webpage of another follower patronizing the follower.

In yet another aspect the system include an admired party node registered with a service provider module to integrate a web widget provided by the service provider module, a follower node (e.g., the follower node may purchase an offering of the web widget of the admired party node based on an empathy relationship between the admired party node and the follower node formed by a charismatic influence of the admired party node on the follower node) registered with the service provider module to import the web widget to a webpage of the follower node, and a community module of the service provider module to link the admired party node and the follower node using the web widget.

The system may also include a global shopping cart module of the service provider module to track individual transactions of the follower node across the web widget of the admired party node and the web widget on the follower node to enable the follower node to checkout at any point in time when the follower node is logged on with the service provider module. The system may further include a content management module of the service provider module to enable the admired party node to control content data he published on the admired party node. Moreover, the system may include an inventory management module of the service provider module to process inventory data communicated between the admired party node and the follower node.

The methods, systems, and devices disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a network of admired parties each having an integrated reusable commerce engine provided through a charisma monetization module supported through a network of offering distributors, according to one embodiment.

FIG. 2 is an exploded view of the service provider module of FIG. 1, according to one embodiment.

FIG. 3 is an exploded view of the admired party module of FIG. 1, according to one embodiment.

FIG. 4 is a table view of content referenced by the profile database of FIG. 2, according to one embodiment.

FIG. 5 is a user interface view of the mark-up language page of FIG. 3 associated with the admired party module of FIG. 1, according to one embodiment.

FIG. 6 is a user interface view of the service provider module of FIG. 1, according to one embodiment.

FIG. 7 is a diagrammatic representation of a data processing system capable of processing a set of instructions to perform any one or more of the methodologies herein, according to one embodiment.

FIG. 8 is an interaction diagram of a process flow between the service provider module, the admired party module and the follower device of FIG. 1, according to one embodiment.

FIG. 9 is a process flow to provide a holistic commerce solution to an admired party, according to one embodiment.

FIG. 10 is a process flow to integrate a branded commerce engine provided by a third party, according to one embodiment.

FIG. 11 is a system view of a service provider module communicating with an admired party webpage and follower webpages through a network, according to one embodiment.

FIG. 12 is an exploded view of the widget module of FIG. 11, according to one embodiment.

FIG. 13 is a user interface view of a web widget illustrating a product widget, a media widget and an idea widget, according to one embodiment.

FIG. 14 is a user interface view of the media widget and the idea widget illustrating blogs, according to one embodiment.

FIG. 15 is a user interface view displaying a promotional graphic data on the web widget, according to one embodiment.

FIG. 16 is a process flow of forming a social network between the admired party and the follower of the admired party, according to one embodiment.

FIG. 17 is a process flow of globally updating the web widget of the admired party webpage and the replica of the web widget on the follower webpage, according to one embodiment.

Other features of the present embodiments will be apparent from the accompanying drawings and from the detailed description that follows.

### DETAILED DESCRIPTION

A method and system of synchronizing data processed through web widgets distributed across network nodes is disclosed. In the following description, for the purposes of explanation, numerous specific details are set forth in order to provide a thorough understanding of the various embodiments. It will be evident, however to one skilled in the art that the various embodiments may be practiced without these specific details.

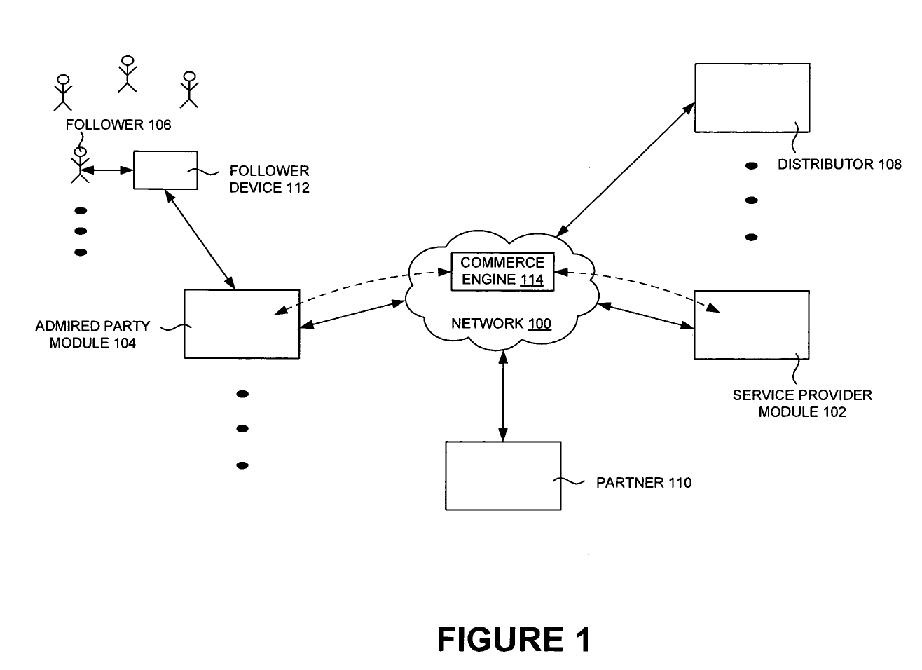

In one embodiment, a method of a service provider module (e.g., the service provider module 1102 of FIG. 1) includes linking an admired party webpage (e.g., the admired party webpage 1112 of FIG. 1) of an admired party with a follower webpage (e.g., the follower webpages 1122A-N of FIG. 1) of a follower of the admired party when a replica of a web widget (e.g., the replica of product widget 1124 and the replica of media widget 1126 of FIG. 1) of the admired party webpage 1112 is integrated to the follower webpages 1122A-N (e.g., the follower purchases an offering of the web widget of the admired party webpage 1112 and/or the replica of the web widget 1124-1126 on the follower webpage 1122A-N based on an empathy relationship between the admired party and the follower formed by a charismatic influence of the admired party on the follower), assigning common module identification to the web widget (e.g., the product widget 1116, the media widget 1118, and the idea widget 1120 of FIG. 1) of the admired party webpage 1112 and to the replica of the web widget 1124-1126 on the follower webpage 1122A-N, and simultaneously updating the admired party webpage 1112 and the follower webpage 1122A-N using the common module identification based on data processed in the web widget of the admired party webpage and the replica of the web widget 1124-1126 on the follower webpage 1122A-N.

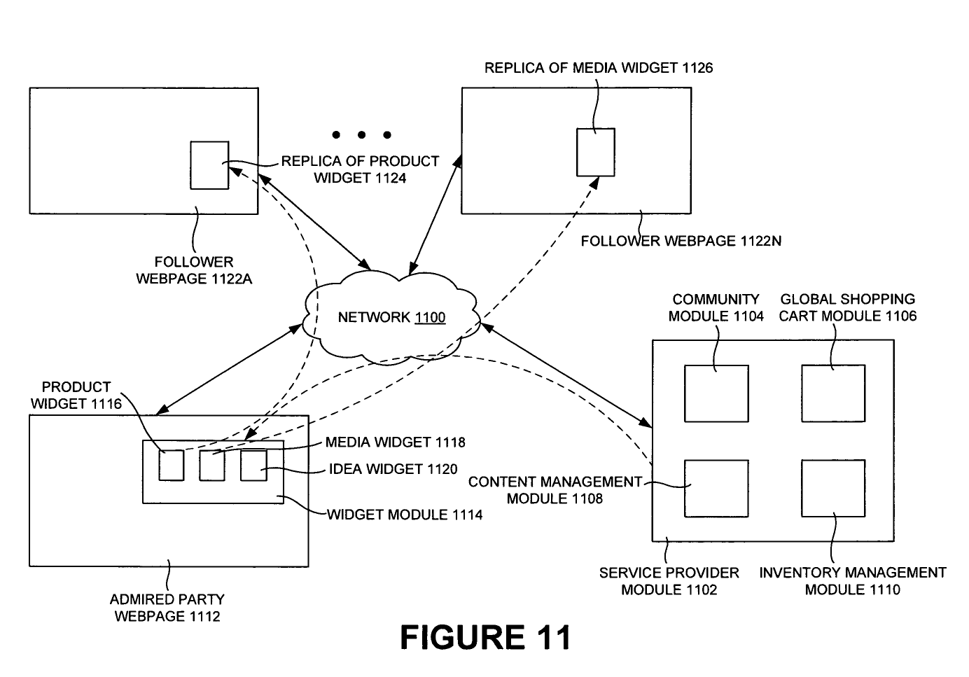

In another embodiment, a method of an admired party module includes installing (e.g., using a widget module 1114 of FIG. 11) a web widget to an admired party webpage (e.g., the admired party webpage 1112 of FIG. 11) of an admired party through integrating a code of the web widgets 1116-1120 to the admired party webpage 1122 of the admired party, linking the web widgets 1116-1120 of the admired party webpage 1122 with the replica of the web widget of the admired party webpage 1112 imported to a follower webpage (e.g., the follower webpages 1122A-N of FIG. 11) of a follower (e.g., the follower may import the replica of the web widget of the admired party webpage 1112 to the follower webpage 1122A-N to patronize the admired party) of the admired party. The method further includes globally updating the web widgets 1116-1120 of the admired party webpage 1112 and the replica of the web widget 1124-1126 on the follower webpage (e.g., the follower webpages 1122A-N) based on transaction data of the web widget of the admired party webpage 1112 and the follower webpage 1122A-N.

In yet another embodiment, a system includes an admired party node registered with a service provider module (e.g., a service provider module 1102 of FIG. 1) to integrate a web widget provided by the service provider module 1102, a follower node registered with the service provider module 1102 to import the web widget to a webpage of the follower node (e.g., the follower node may purchase an offering of the web widget of the admired party node based on an empathy relationship between the admired party node and the follower node formed by a charismatic influence of the admired party node on the follower node), a community module (e.g., a community module 1104 of FIG. 1) of the service provider module 1102 to link the admired party node and the follower node using the web widget.

FIG. 1 is a system view of a network of admired parties, having a service provider module 102, an admired party module 104, a follower 106, a distributor 108, a partner 110, a follower device 112, and a commerce engine 114, which may communicate through a network 100 (e.g., internet). The service provider module 102 may provide a holistic commerce solution (e.g., a charisma monetization solution) to an admired party (e.g., associated with the admired party module 104) through an integration of an integrated, reusable and/or branded commerce engine (e.g., the commerce engine 114 may be provided by the service provider module 102) in a mark-up language page (e.g., a website, a blog, etc.) of the admired party.

The admired party may be any party (e.g., a person, a persona, a representative of a non-human entity) having a social, religious, political, virtual, personal etc. significance (e.g., a blogger, a celebrity, an artiste, a friend of another party, etc.) to another party (e.g., the follower 106). The follower 106 (e.g., a fan, a friend, a patron, a supporter etc. of the admired party associated with the admired party module 104) may communicate with the admired party module 104 (e.g., may visit a website of the admired party) through the follower device 112 (e.g., a desktop computer, a laptop, a PDA, a telecommunications device, etc.) to engage in a transaction (e.g., to purchase branded offerings, based on an empathy with and/or a charisma of, the admired party) through the mark up language portal associated with the admired party module 104.

For example, the branded offerings may be digital media offerings (e.g., digital music), physical offerings (e.g., apparel) and/or services (e.g., tickets, political message memorabilia, etc.). The transaction initiated by the follower 106 through the mark up language portal (e.g., using the commerce engine 114 associated with the admired party module 104 and/or provided by the service provider module 102) of the admired party may be at a price based on an empathy relationship between the follower 106 and the value (e.g., the interests, the cause, etc.) of the admired party. The transaction may be fulfilled based on a drop-ship (e.g., shipping to order) of the offerings to the follower 106, arranged through a network of distributors (e.g., such as the distributor 108 illustrated in FIG. 1) associated with the service provider module 102 (e.g., the service provider module 102 may maintain no inventory of the branded offerings) when the follower 106 purchases an offering on the mark-up language page of the admired party (e.g., and/or generated using the admired party module 104).

For example, the admired party may be a celebrity and/or a blogger (e.g., a web logger) who primarily provides a content-based information (e.g., on his/her website) without profiting from his/her popularity (e.g., independent of monetizing a brand identity associated with the admired party module 104). A growth of the brand identity (e.g., of the admired party) may be a result of a popularity of the content-based information in a geographic region.

The partner 110 may be a strategic, business and/or service partner (e.g., a social network provider, a relationship network, etc.) associated with the service provider module 102. For example, the partner 110 may be a friendship network of users having profiles listed on mark-up language pages in which the service provider module 102 may integrate commerce engines (e.g., the commerce engine 114 illustrated in FIG. 1) based on preferences set by the users (e.g., the users may be admired parties of other users) and/or the partner 110.

The commerce engine 114 may be a branded commerce engine (e.g., a program script, a code, a plug-in, a utility, etc.) integrated into the mark-up language page of the admired entity. The commerce engine 114 may provide the follower 106 of the admired party module 104 a complete process for selecting, reviewing and/or purchasing the branded offerings promoted on the mark-up language page of the admired party.

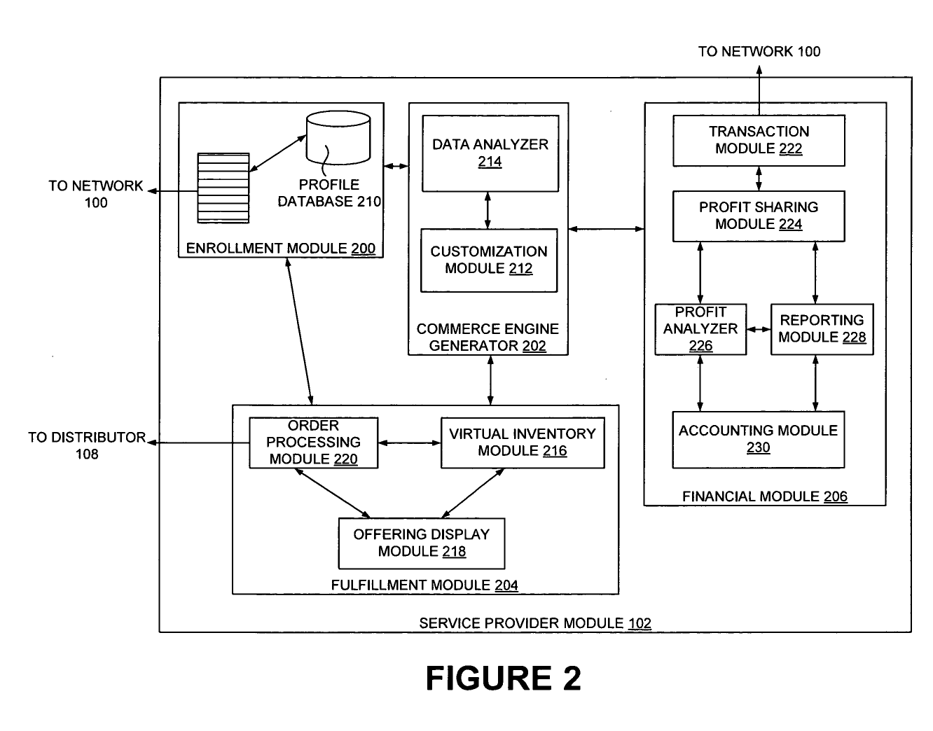

FIG. 2 is an exploded view of the service provider module 102 of FIG. 1, having an enrollment module 200, a commerce engine generator module 202, a fulfillment module 204 and/or a financial module 206, according to one embodiment. The enrollment module 200 may include an enrollment form 208 and/or a profile database 210. The commerce engine generator module 202 may include a customization module 212 and/or a data analyzer 214.

The fulfillment module 204 may include a virtual inventory module 216, an offering display module 218 and/or an order processing module 220. The financial module 206 may include a transaction module 222, a profit sharing module 224, a profit analyzer 226, a reporting module 228 and/or an accounting module 230. The enrollment module 200 may process (e.g., capture, generate, record, track, store, manage, etc.) an enrollment (e.g., an online signup) of the admired party (e.g., the admired party associated with the admired party module 104 of FIG. 1) with the service provider module 102 based on a profile of values (e.g., interests) of the admired party.

For example, the enrollment module 200 may process a value parameter specified by the admired party (e.g., based on a personal value, a political value, a religious value, a professional value, a social value and/or a controversial value, etc.) through the enrollment form 208 (e.g., a template of choices) communicated to the admired party (e.g., through the admired party module 104).

The value parameters associated with various admired party modules may be referenced (e.g., recorded, stored, tracked, etc.) by the profile database 210. The commerce engine generator module 202 may determine (e.g., generate, calculate, etc. using various algorithms, mapping processes and/or predefined settings, etc.) a customized commerce engine (e.g., the commerce engine 114 of FIG. 1) for the mark up language portal associated with the admired party module 104, through the customization module 212 and/or based on a communication with the enrollment module 200.

The customization module 212 may refresh the at least one offering on the mark-up language page of the admired party based on a change in the value parameter specified by the admired party (e.g., using the enrollment form 208). For example, the data analyzer 214 may communicate with the customization module 212 and/or the admired party module 104 to process (e.g., analyze, track, capture, etc.) the value parameters (e.g., the profile) communicated by the admired party module 104 to the enrollment module 200, and/or to process (e.g., facilitate) a synchronization (e.g., a modification, an update, a refreshing) of the customization module 212 and/or the enrollment module 200.

The fulfillment module 204 may process an end-to-end purchase to sale of the branded offering on behalf of the admired party associated with the admired party module 104. The virtual inventory module 216 may process (e.g., create, render, etc.) a virtual inventory (e.g., a stock of branded offerings visible in an online environment but not carried as physical inventory by the admired party module 104 or the service provider module 102) customized to the value parameter(s) of the admired party on the mark-up language page of the admired party (e.g., the branded offerings in the virtual inventory may be available for purchase to the follower 106 of the admired party using the commerce engine 114 integrated into the mark-up language page associated with the admired party module 104.

The offering display module 218 may process data and/or meta data associated with the display (e.g., through a graphical user interface) of the virtual inventory on the mark-up language page of the admired party module 104. In one embodiment, the offering display module 218 may enable the follower 106 of the admired party to perform a transaction (e.g., purchase branded offering using the integrated commerce engine of the admired party module 104) in its entirety without leaving a particular mark-up language page (e.g., website) when the transaction is initiated.

For example, the offering display module 218 may strip a web browser embodying the mark-up language page of header fields and disguise the browser as a frame embedded directly in the mark-up language page as a session-less pop-in to the mark-up language page (e.g., the follower 106 using the mark-up language page may perceive the transaction as taking place seamlessly in the same browser window). The follower 106 may be able to perform the entire transaction through a single click of a pointing device (e.g., a mouse) through an iframe technology (e.g., by embedding a document within another document) whereby the follower may be able to view and/or provide information (e.g., detailed product specification, buyer information, credit card information, shipping and/or handling information, etc.) in a single browser window embedded in the mark-up language page, without leaving the mark-up language page of the admired party module 104. The single browser window may have multiple panes (e.g., shipping information pane, credit card information pane etc.) that may have drop down form(s) that the follower may activate (e.g., by selection) and fill information (e.g., shipping information, credit card information, etc.).

In another embodiment, the offering display module 218 may mask the identification (e.g., universal resource locator) of the service provider module 102 such that the entity associated with the service provider module 102 is not visible to the follower 106 engaged in the transaction. The offering display module 218 may also remember settings (e.g., personal information, credit card information, etc.) to allow the follower 106 to execute a transaction without entering any information (e.g., by just clicking the ‘buy’ button).

In yet another embodiment, the offering display module 218 may rotate the branded offering along with other branded offerings on the mark-up language page of the admired party module 104 (e.g., based on predefined settings, based on the admired party's preferences, based on a customization of the virtual inventory, based on a temporal marker, etc.). The offering display module 218 may also optimize the mark-up language page of the admired party module 104 for a single offering (e.g., personalized based on the content and/or the interests of the admired party associated to the mark-up language page) to allow the follower 106 to instantly purchase the single offering (e.g., based on an impulse-buy of the follower) through a single click purchase mechanism (e.g., by using the iframe technology). The display of the offering may also be optimized so as to preserve subtleness of the mark-up language page (e.g., maintain identity of a web page) so that the follower 106 and/or the admired party module 104 may not find the offerings and/or the mark-up language page obtrusive (e.g., a shopping website).

The order processing module 220 may communicate with the admired party module 104, the follower device 112 and/or distributors 108 to process (e.g., capture, record, track, communicate, etc.) an order (e.g., a selection of branded offerings, a virtual shopping cart, etc. to be purchased by the follower 106 through the commerce engine 114 of the admired party module 104). For example, the order processing module 220 may communicate with the distributor 108 associated with the branded offerings selected by the follower 106 to synchronize a drop-shipping of the offerings to the follower 106 by the distributor 108. The entire fulfillment process may be fully integrated within the branded commerce engine and may not require external shopping applications (e.g., shopping carts, 3rd party catalogues, etc) and/or web service interface (e.g., 3rd party application programming interface).

The transaction module 222 may process (e.g., capture, track, record, communicate, store, monitor, analyze, etc.) financial data and/or meta data associated with the transaction initiated by the follower 106 through the commerce engine 114 of the admired party module 104. The transaction module 222 may process financial preferences and/or information associated with the follower 106 who purchases the offering(s) through the commerce engine 114 to monetize the promotion of the branded offering through the admired party module 104.

For example, the price (e.g., of the offering, and/or to the follower 106) associated with the monetizing of the offering is at a premium (e.g., is higher) to a market price of a comparable offering through a goodwill relationship formed between the follower and the admired party over a series of communications of the admired party made accessible to the follower through a web log structure (e.g., the follower 106 may be a fan of the admired party's blog).

In another embodiment, the price may be at a premium to a market value of the offering based on an empathy relationship between the follower 106 and the admired party formed through the charismatic influence of the admired party on the follower 106, and/or based on an empathy relationship between the follower 106 and the value(s) of the admired party (e.g., the value(s) may be known and/or perceived by the follower 106). The profit sharing module 224 may process (e.g., determine, calculate, etc.) shares (e.g., splits, distributions, allotments, etc.) of a profit (e.g., derived from a revenue) generated through the purchase of the offering by the follower 106 (e.g., the payment processed of the follower 106 may be communicated by the commerce engine 114 of the admired party module 104 to the service provider module 102).

In one embodiment, the profit sharing module 224 may provide a portion of the profit to the admired party associated with the admired party module 104. The profit sharing module 224 may determine (e.g., analyze, calculate, compute, etc.) the portion of the profit using the profit analyzer 226. For example, the profit sharing module 224 may provide a transparent financial visibility to the admired party of a wholesale purchase of the branded offering (e.g., by the service provider module 102, based on information submitted in the enrollment form 208 by the admired party, and/or from the distributor 108 illustrated in FIG. 1) to the retail sale of the branded offering (e.g., through the commerce engine 114) to any number of followers 106. The profit sharing module 224 may share a significant portion of the margin (e.g., ranging from 10%-35% of downloadable music margin, 50% on books and/or electronic media, 70% on apparels, etc.) with the admired party associated with the admired party module 104.

The reporting module 228 may notify the admired party of the portion of data and/or meta data associated with the portion of the profit payable to the admired party (e.g., the portion of the profit derived from the transaction initiated by the follower 106 through the commerce engine 114 of the mark language page of the admired party module 104).

The accounting module 230 may process (e.g., capture, store, track, records, monitor, analyze, etc.) data and/or meta data associated with wholesale (e.g., base, volume-based, etc.) prices of branded offerings (e.g., quoted by distributors 108 of the branded offerings), retail prices (e.g., of branded offerings on the mark-up language page of the admired party module 104 (e.g., at a premium of the wholesale price), revenue amounts and/or profit distributions to various parties (e.g., to the admired party module 104, the distributor 108, the partner 110 and/or the service provider module 102). The reporting module 228 and/or the accounting module 230 may provide the admired party with real time user statistics (e.g., number of transactions) and/or revenue accounting information (e.g., break-up of revenue) associated to an offering.

In one embodiment, the accounting module 230 may communicate with the commerce engine 114 of the admired party module 104 to process information associated with the virtual inventory of branded offerings (e.g., data and/or meta data associated with a user traffic, an interest, a market, a record and/or log of activity, a sales history, etc.).

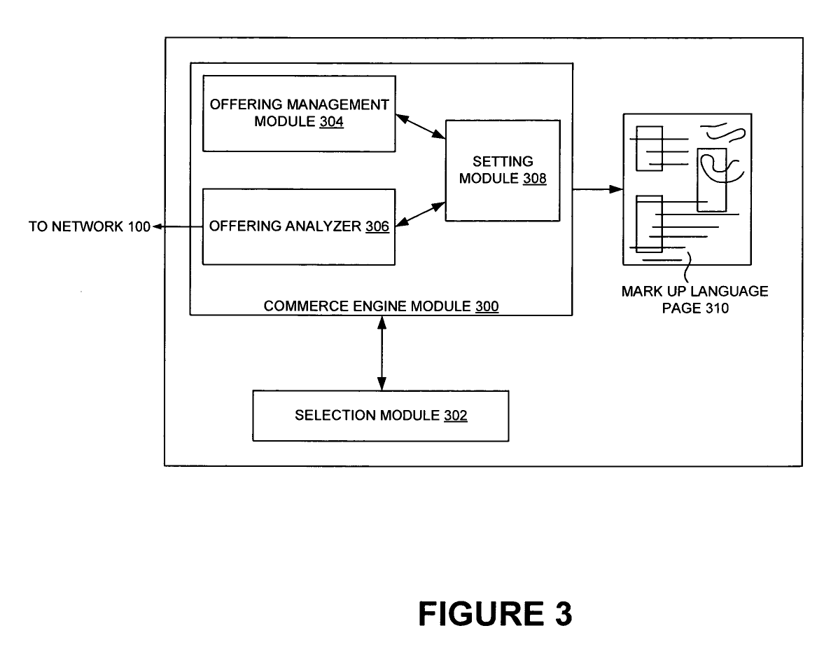

FIG. 3 is an exploded view of an admired party module 104 of FIG. 1, having a commerce engine module 300 and a mark-up language page 310, according to one embodiment. The commerce engine module 300 may include a management module 304, an offering analyzer 306 and/or a setting module 308. The management module 304 may provide the admired party (e.g., associated with the admired party module 104) with an access to control (e.g., an ability to modify) the offering, the virtual inventory and/or aspects of the commerce engine 114 (e.g., illustrated in FIG. 1) of the mark-up language page 310 (e.g., a website, a blog site) generated by the admired party module 104, based on preferences of the admired party.

For example, the management module 304 may automatically populate the mark-up language page 310 (e.g., the website) of the admired party with at least one offering (e.g., the branded offering) representing a value of the admired party (e.g., a political value, a social value, a religious value, a personal value, etc.) when the admired party integrates the branded commerce engine (e.g., the commerce engine 114) in the mark-up language page 310. The admired party may also be able to customize the description of an offering (e.g., through simple text, thumbnail, etc.).

The offering analyzer 306 may process (e.g., compare, analyze, track, etc.) the virtual inventory of the commerce engine 114 (e.g., illustrated in FIG. 1) with data and/or meta data communicated by the setting module 308. For example, the offering analyzer 306 may communicate with the service provider module 102 to determine whether the virtual inventory (e.g., having branded offerings generated based on preferences of the admired party) matches the preferences (e.g., statically, temporally, periodically and/or dynamically) communicated by the admired party (e.g., through the enrollment module 200 of FIG. 2, the setting module 308 and/or the management module 304).

The setting module 308 may process (e.g., capture, track, store, analyze, record and/or monitor) settings associated with the preferences of the admired party (e.g., associated with the settings for the offerings of the virtual inventory and/or the commerce engine 114 of the mark-up language page 310). For example, the admired party may modify preferences and/or values he/she communicated with the enrollment module 200 of FIG. 2, and or may wish the commerce engine 114 to recognize consistent, predicted and/or a base set of future preferences, rules and/or values (e.g., associated with the admired party) through the setting module 308 of the commerce engine module 300. In one embodiment, a communication by the admired party through the setting module 308 may update the profile database 210 of FIG. 2.

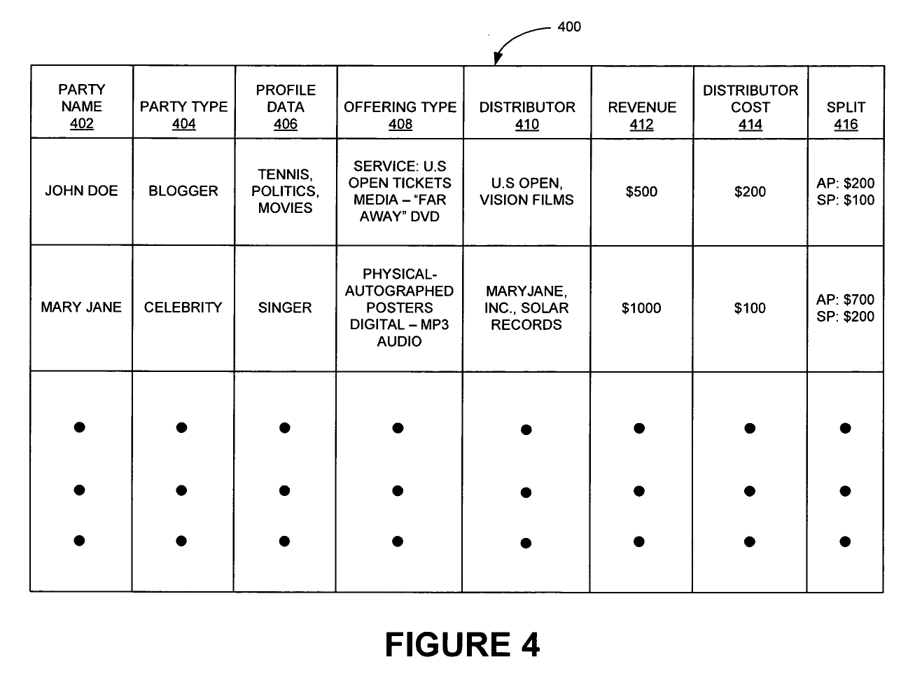

FIG. 4 is a table view 400 of content referenced by the profile database 210 of FIG. 2, having a party name field 402, a party type field 404, a profile data field 406, an offering type field 408, a distributor field 410, a revenue field 412, a distributor cost field 414, and a split field 416, according to one embodiment. The party name field may display an identifier associated with the admired party (e.g., having an admired party module 104).

The party type field 404 may display a label indicating a nature of a charisma of the admired party that may be perceptible to a follower 106 in a context (e.g., a social context, a web presence context, a political context, etc.). The profile data field 406 may display identifiers referencing values (e.g., interests, causes, beliefs, hobbies, etc.) of the admired party. The offering type field 408 may display labels indicating the nature of the offerings (e.g., digital, physical, service) provided by the commerce engine 114 of FIG. 1 on the mark-up language page generated by the admired party module 104.

The distributor field 410 may display an identifier referencing the distributor (e.g., the distributor 108 illustrated in FIG. 1. The revenue field 412 may display a revenue (e.g., of the service provider module 102) generated by (e.g., derived from) the purchase of the offering by the follower 106 through the commerce engine 114 integrated into the mark-up language page of the admired party module 104.

The distributor cost field 414 may display a value associated with the wholesale price of the offering (e.g., the distributor's price and/or cost of services rendered to the service provider module 102 for the branded offer). The split field may display a distribution of a profit (e.g., the revenue referenced in the revenue field 412 less the distributor cost referenced in the distributor cost field 414) between the service provider module 102 and the admired party module 104.

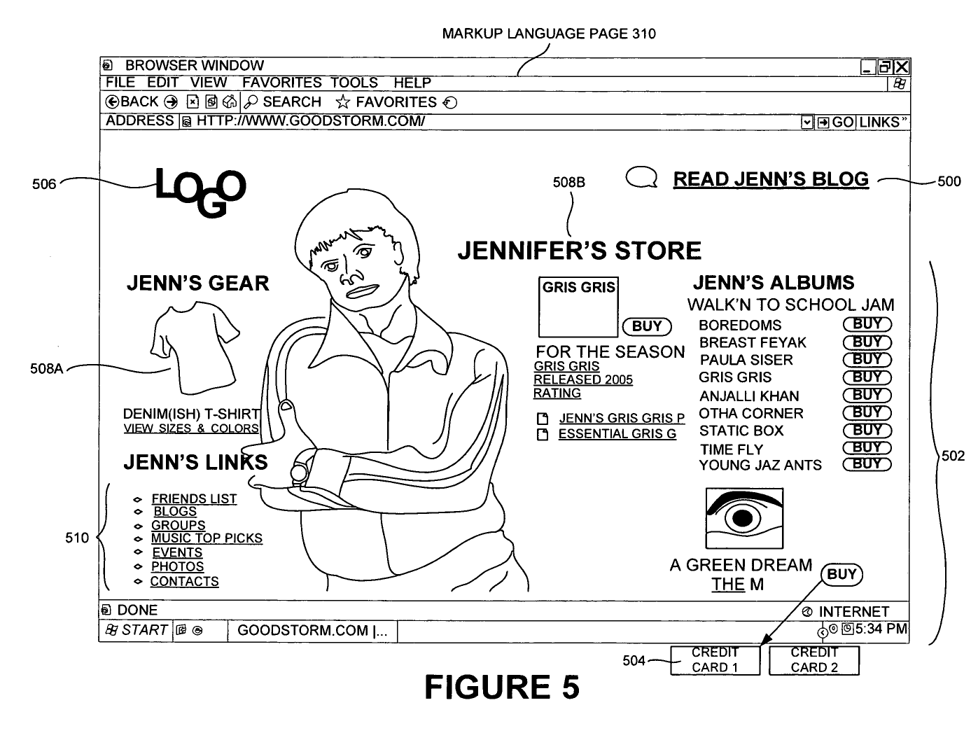

For example, two hypothetical admired parties of the profile database 210 are illustrated in FIG. 5. The party name field 402 displays “John Doe” and Mary Jane,” indicating the name of the admired parties. The party type field indicates “Blogger” and “Celebrity,” indicating that John Doe may have a charisma amongst followers 106 who may be readers of his blog, and that Mary Jane may have a social charisma amongst followers 106 based on her status as a celebrity.

The profile data field 406 displays “Tennis, Politics, Movies” and “Singer,” indicating that John may have values and/or interests including tennis, politics and/or movies, while Mary may be a celebrity singer. The offering type field 408 displays “service—U.S. Open tickets, Digital Media—Far Away DVDs” and “Physical—Autographed Posters, Digital—mp3 Audio,” indicating that John's virtual inventory of branded offerings (e.g., provided on John's blog through the commerce engine 114 illustrated in FIG. 1) includes services such as tickets to a prominent tennis tournament and/or media such as digital video discs of a motion picture (e.g., movie), and that Mary Jane's virtual inventory of branded offerings (e.g., provided on Mary Jane's website) includes physical offerings such as autographed posters of Mary Jane and/or digital media such as audio recordings of her music (e.g., in an mp3 format).

The distributor field 410 displays “U.S. Open, Vision Films” and “MaryJane, Inc., Solar Records,” indicating that the distributor associated with drop-shipping the offerings promoted on John's virtual inventory to followers 106 who purchase the offerings on John's blog site is “U.S. Open” for the tennis tournament tickets and “Vision Films” for the DVD movies, while the distributors associated with Mary Jane's virtual inventory are “MaryJane, Inc.” for the autographed posters and “Solar Records” for the audio recordings of her music.

The revenue field 412 displays “$500” and “$1000,” indicating that followers 106 of John's blog site have purchased $500 (e.g., have submitted a total of $500 in payment) of John's branded offerings, while followers 106 of Mary Jane's website have purchased $1000 of her branded offerings. The distributor cost field 414 displays “200” and “100,” indicating that the wholesale price (e.g., the price charged by the distributors 108 for providing and shipping the branded offerings ordered by the followers 106) for John's sales (e.g., the offerings purchased by followers 106 through the integrated branded commerce engine on John's blog site) is $100, while the wholesale price (e.g., the cost to the service provider module of the services rendered by the distributor 108) for Mary Jane's offerings is $100.

The split field 416 displays “AP: $200, SP: $100” and “AP: $700, SP: $200,” indicating that in the case of John, the portion of the profit (e.g., the revenue less the distributor cost) from the transactions (e.g., from the payments processed of the followers 106 who purchased offerings through the admired party module 104 associated with John) that goes to John (e.g., the admired party, using the service provider module 102) is $200, while $100 goes to the service provider module 102. In the case of Mary Jane, the portion of the profit from the transactions through Mary Jane's website that goes to Mary (e.g., the admired party) is $700, while $200 goes to the service provider module 102.

FIG. 5 is a user interface view of the mark-up language page 310 of FIG. 3 associated with the admired party module 104 of FIG. 1, having a prompt view 500, a commerce engine view 502, an embedded payment processing view 504, a logo view 506, virtual inventory views 508A and 508B, and a links view 510, according to one embodiment.

The prompt view 500 may display a message customized to the admired party (e.g., “Jennifer,” based on information provided by Jennifer in a communication with the enrollment module 200 of FIG. 2). The prompt view 500 may alert the viewer (e.g., the follower 106) of the admired party (e.g., “Jennifer”) of other content associated with Jennifer (e.g., a blog site of Jennifer's). The commerce engine view 502 may display content associated with functions of the commerce engine 114 illustrated in FIG. 1 (e.g., may provide options for the follower 106 to view, compare, search, order and/or purchase, etc. branded offerings promoted by Jennifer).

The embedded payment processing view 504 is an example illustration of a function of the commerce engine (e.g., may not be visible to a viewer such as the follower 106). The commerce engine 114 illustrated in the commerce engine view 502 may reference an external payment verification authority (e.g., any number of credit card companies) to process and/or finalize a purchase transaction made by the follower 106 on Jennifer's mark-up language page (e.g., the mark-up language page 310).

The logo view 506 may display a textual and/or graphic visualization (e.g., may be designed by the admired party to be in alignment with a value of the admired party). The virtual inventory views 508A and 508B display a menu of branded offerings being promoted by the admired party (e.g., “Jennifer”). The virtual inventory may include selections, options to search the inventory, preferences, etc.

The service provider module 102 and Jennifer (e.g., the admired party associated with the user interface view illustrated in FIG. 5) may not physically stock any of the offerings promoted in the virtual inventory views (e.g., the offerings and/or items may be drop-shipped by a distributor 108 to the purchaser such as the follower 106 based on a the follower 106 completing an order through the commerce engine view 502).

The links view 510 may notify the viewer of other mark-up language pages that may be of interest to the viewer (e.g., the follower 106). For example, the other mark-up language pages may be associated with admired parties who are known to Jennifer (e.g., based on the follower 106 having an empathy and/or affinity for Jennifer based on a charismatic influence of hers). The follower 106 may be likely to want to visit websites and/or blogs (e.g., the mark-up language page 310) associated with admired parties who are known to Jennifer.

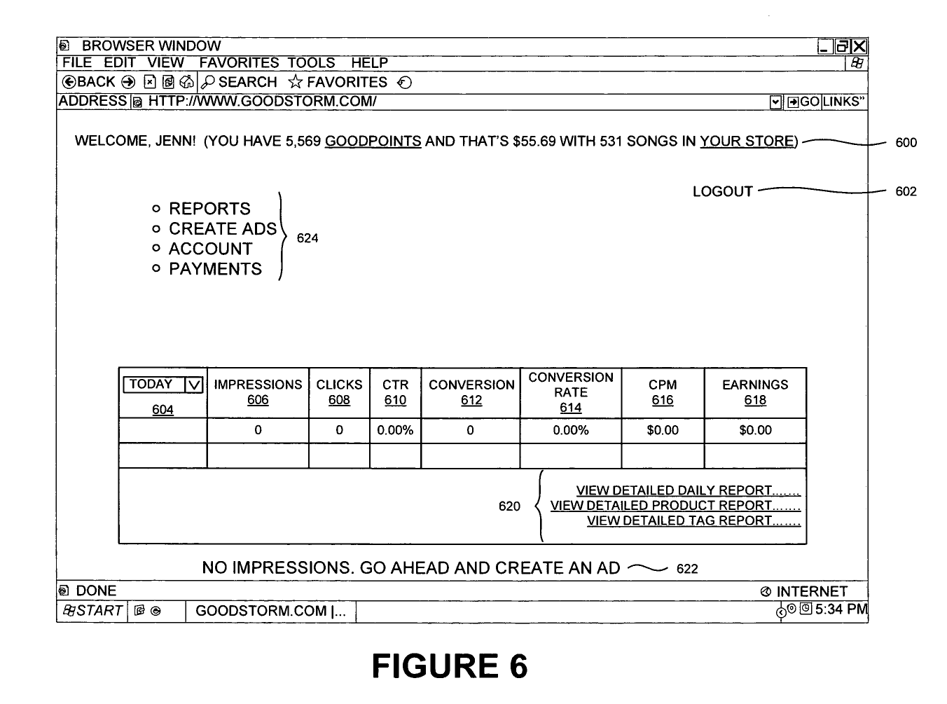

FIG. 6 is a user interface view of the service provider module of FIG. 1, having a welcome view 600, a logout view 602, a today view 604, an impressions view 606, a clicks view 608, a CTR (e.g., click-through rate) view 610, a conversion view 612, a conversion rate view 614, a CPM (e.g., cost per thousand impressions) view 616, an earnings view 618, a report view 620, a create ad view 622, and an options view 624, according to one embodiment.

The welcome view 600 may display a welcome message (e.g., to the admired party associated with the service provider module 102) based on information provided by the admired party (e.g., through a communication with the enrollment module 200 and/or the profile database 210 of FIG. 2). The welcome view may also include indicators of Jennifer's offerings, virtual inventory and/or account value (e.g., may display a point-based index value of the offerings in Jennifer's virtual inventory and/or account with the service provider module based on a communication with the profile database 210).

The logout view 602 may provide the admired party an option to exit the user interface view. The today view 604 may display data, meta data and/or statistical information associated with the date (e.g., the day, the calendar date) on which the admired party accesses the user interface view. For example, the today view 604 may notify the admired party of significant events (e.g., associated with the mark-up language page 310, the commerce engine 114 and/or the virtual inventory associated with the admired party) that occurred on the same day.

The impressions view 606 may display a value indicating a number of times an impression (e.g., a banner display, a pop-in, a link, etc.) is displayed of the offering in the admired party's virtual inventory (e.g., generated based on actions of the viewers). The clicks view 608 may display a value indicating a number of times viewers (e.g., the followers 106 of the admired party) may have clicked (e.g., with a mouse, with a touchpad, with a keyboard key, with a trackball, etc.) on various items (e.g., associated with the offerings) displayed on the mark-up language page 310 of the admired party (e.g., associated with the admired party module 104).

The CTR (e.g., click-through rate) view 610 may display a value indicating a ratio (e.g., a percentage, a metric, a decimal number, etc.) of the number of times the impression is displayed to the number of times the viewer clicks on the display (e.g., clicks through). The conversion rate view 614 may indicate a value expressing a number of conversions (e.g., successful transactions, requests for further information, etc.) relative to (e.g., as a fraction of) the number of viewers (e.g., the followers 106) that have visited the mark-up language page 310 (e.g., website) associated with the admired party. The CPM (e.g., cost per thousand) view 616 may indicate a value for the cost (e.g., to the admired party, associated with the display of the impression for the offering) per every thousand impressions (e.g., displays of the offering generated by the viewers of the admired party's mark-up language page). The earnings view 618 may indicate a currency value of the total conversions (e.g., completed transactions, purchases, etc.) generated within a time frame. The report view 620 may provide the admired party with options (e.g., for visualizing, summarizing, expressing, recording, exporting and/or interpreting, etc.) the data, meta data and/or statistical information displayed and/or not displayed elsewhere in the user interface view.

The content displayed in the create ad view 622 may depend on certain value thresholds of the number of impressions indicated in the impressions view 606 (e.g., may prompt the admired party to create an advertisement and/or marketing effort to improve the number of impressions generated by viewers of the mark-up language page of the admired party (e.g., followers 106 of the admired party). The options view 624 may provide the admired party with options (e.g., choices) to access, extract, refer to, generate and/or reference, etc. various data, information, and/or meta data (e.g., the admired party's preferences, profile settings, reports for activity on the mark-up language page 310 of the admired party, financial options for the admired party, options for the admired party to modify content on the mark-up language page 310, settings for the commerce engine of the mark-up language page 310 associated with the admired party, etc.).

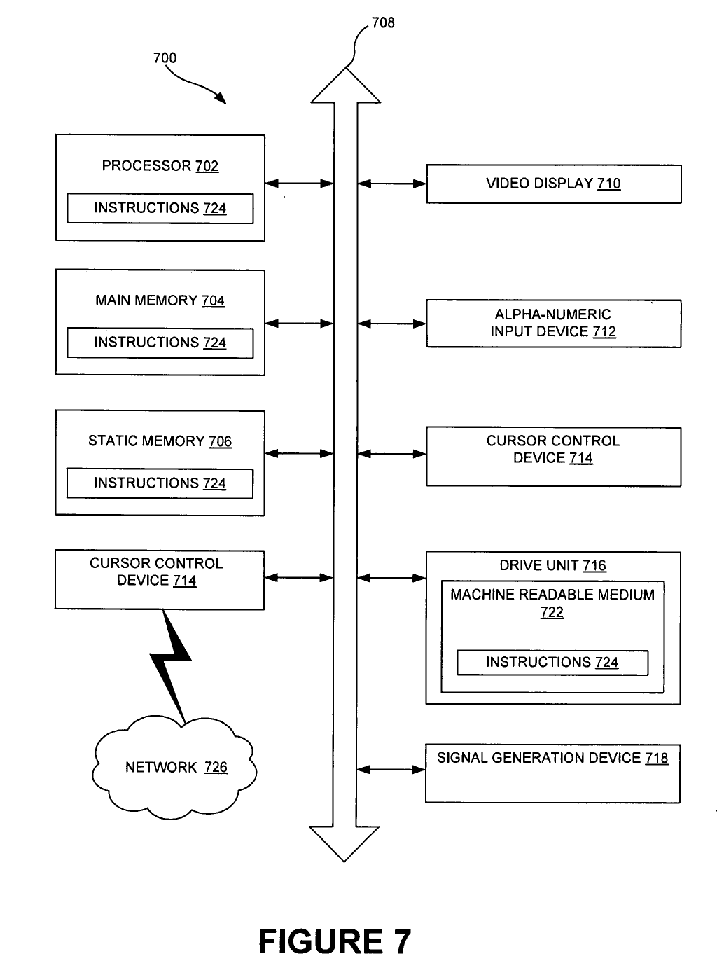

FIG. 7 is a diagrammatic representation of a computer system 700 capable of processing a set of instructions to perform any one or more of the methodologies herein, according to one embodiment. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment.

The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 700 includes a processor 702 (e.g., a central processing unit (CPU) a graphics processing unit (GPU) and/or both), a main memory 704 and a static memory 706, which communicate with each other via a bus 708. The computer system 700 may further include a video display unit 710 (e.g., a liquid crystal display (LCD) and/or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies and/or functions described herein. The software 724 may also reside, completely and/or at least partially, within the main memory 704 and/or within the processor 702 during execution thereof by the computer system 700, the main memory 704 and the processor 702 also constituting machine-readable media.

The software 724 may further be transmitted and/or received over a network 726 via the network interface device 720. While the machine-readable medium 722 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

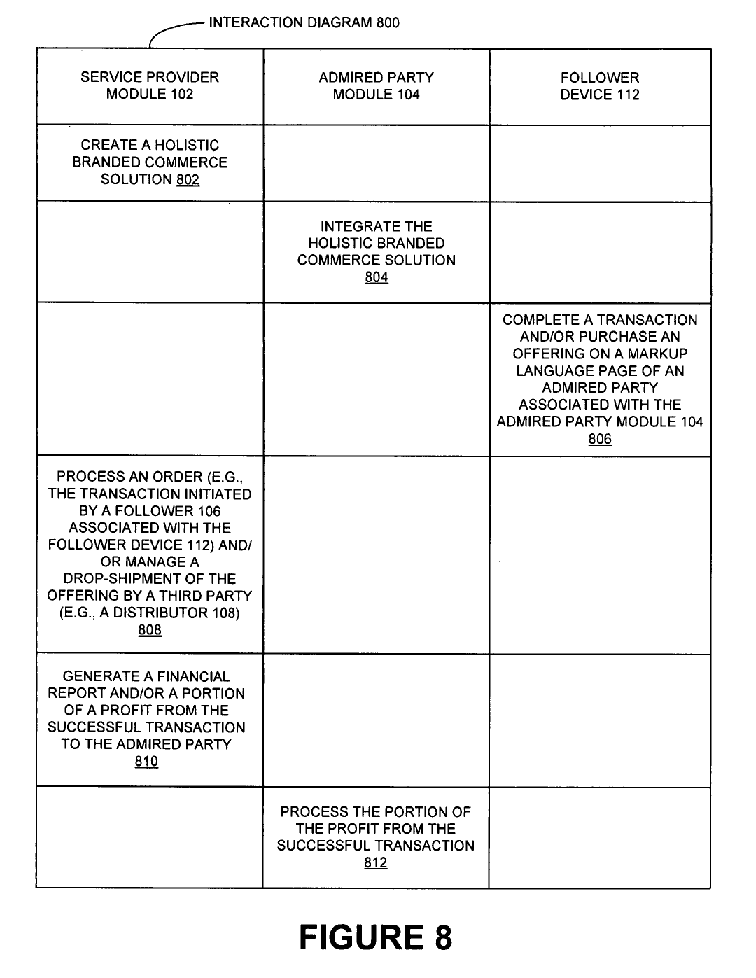

FIG. 8 is an interaction diagram of a process flow between the service provider module 102, the admired party module 104 and the follower device 112 of FIG. 1, according to one embodiment. In operation 802, the service provider module 102 creates a holistic branded commerce solution (e.g., for an admired party to monetize a charismatic influence an/or empathetic influence etc. Over a follower such as the follower 106 illustrated in FIG. 1 through a mark-up language page (e.g., website, blog, etc.). In operation 804, the admired party module 104 integrates (e.g., embeds) the holistic branded commerce solution (e.g., the commerce engine 114 of FIG. 1) into the mark-up language page (e.g., the mark-up language page 310 illustrated in FIG. 3) of the admired party. In operation 806, the follower device 112 (e.g., associated with the follower 106) completes (e.g., initiates and completes) a transaction and/or purchases an offering (e.g., an offering of a virtual inventory) on a mark-up language page (e.g., the mark-up language page 310) of an admired party associated with the admired party module 104.

For example, the follower 106 may purchase the offering a price premium to a market price of a comparable offering, based on an empathy with a value of the admired party (e.g., a personal value, a political value, a religious value, a controversial value, etc.). In operation 808, the service provider module 102 processes an order (e.g., the transaction initiated by the follower 106 associated with the follower device 112), and/or manages (e.g., facilitates) a drop-shipment of the offering by a third party (e.g., a distributor 108). For example, the service provider module 102 and the admired party module 104 may not hold a physical inventory of the offerings on the mark-up language page 310. In operation 810, the service provider module 102 generates a financial report (e.g., using the reporting module 228 of FIG. 2) and/or a portion of a profit from the successful transaction (e.g., determined using the profit analyzer 226 and/or the profit sharing module 224 of FIG. 2) to the admired party. In operation 1012, the admired party module 104 (e.g., associated with the admired party of the mark-up language page 310) processes (e.g., receives) the portion of the profit from the successful transaction.

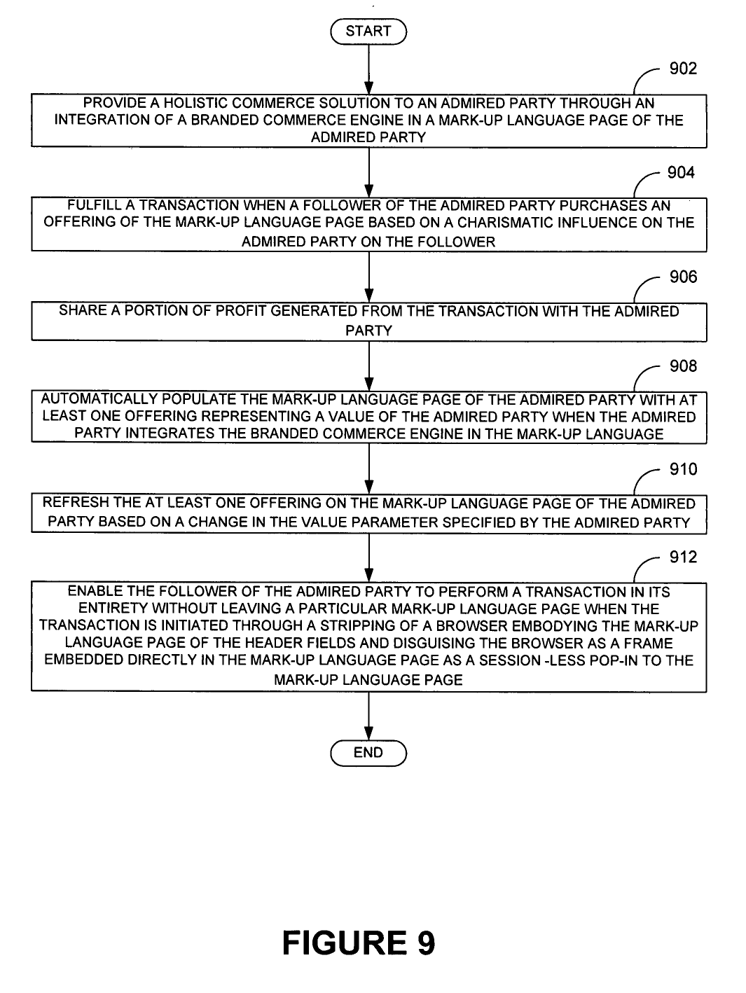

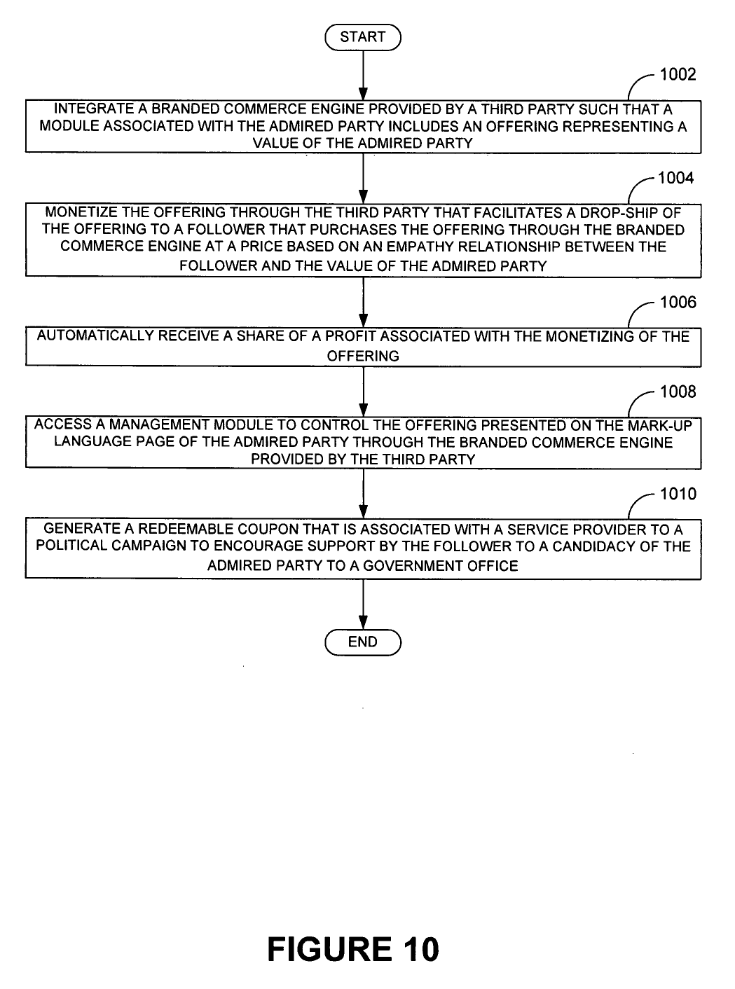

FIG. 9 is a process flow to provide a holistic commerce solution to an admired party, according to one embodiment. In operation 900, a holistic commerce solution is provided (e.g., by the service provider module 102 of FIG. 10 to an admired party (e.g., a celebrity, a blogger, a party having a social presence, a charismatic presence, a web presence, etc.) through an integration of a branded commerce engine (e.g., the commerce engine 114 illustrated in FIG. 1) in a mark-up language page (e.g., a website, a blog, the mark-up language page 310 illustrated in FIG. 3, etc.) of the admired party.

In operation 902, a transaction is fulfilled when a follower (e.g., the follower 106 illustrated in FIG. 1, having an empathy for, and/or appreciation for the admired party and/or values of the admired party) of the admired party purchases an offering (e.g., a digital media offering, a physical offering, a service etc.) on the mark-up language page 310 (e.g., from a virtual inventory provided on the mark-up language page 310) based on a charismatic influence of the admired party on the follower 106. In operation 904, a portion of a profit generated from the transaction is shared with the admired party (e.g., using the profit sharing module 224 of FIG. 2).

In operation 906, the mark-up language page 310 of the admired party is automatically populated with an offering representing a value of the admired party (e.g., may be determined through the enrollment module 200 and/or the profile database 210) when the admired party integrates the branded commerce engine in the mark-up language page 310. In operation 908, the offering on the mark-up language page 310 of the admired party is refreshed based on a change in the value parameter specified by the admired party (e.g., using the management module 304 of the commerce engine module 300 illustrated in FIG. 3).

In operation 910, the follower of the admired party (e.g., associated with the admired party module 104) is enabled to perform a transaction in its entirety without leaving a particular mark-up language page 310 when the transaction is initiated (e.g., using an i-frame technique, through a stripping of a browser embodying the mark-up language page of header fields and/or disguising the browser as a frame embedded directly in the mark-up language page as a session-less pop-in to the mark-up language page, etc.).

FIG. 10 is a process flow to integrate a branded commerce engine (e.g., the commerce engine 114 illustrated in FIG. 1) provided by a third party, according to one embodiment. In operation 1000, a branded commerce engine provided by a third party (e.g., the service provider module 102 illustrated in FIG. 1) is integrated such that a module associated with the admired party (e.g., the admired party module 104 illustrated in FIG. 1) includes an offering representing a value of the admired party (e.g., a political value, a religious value, a social value, a controversial value, a personal value etc.)

In operation 1002, the offering is monetized through the third party that facilitates a drop-ship of the offering (e.g., the distributor 108 illustrated in FIG. 1) to a follower (e.g., the follower 106 of FIG. 1) that purchases the offering through the branded commerce engine (e.g., the commerce engine 114) at a price based on an empathy relationship between the follower 106 and the value of the admired party (e.g., the price may be at a premium to a market value of the offering).

In operation 1004, a share of a profit associated with the monetizing of the offering is automatically received (e.g., by the service provider module 102 and/or the admired party module 104) in operation 1006, a management module (e.g., the management module 304 of FIG. 3) is accessed to control the offering presented on the mark-up language page 310 of the admired party through the branded commerce engine provided by the third party (e.g., the service provider module 102). In operation 1008, a redeemable coupon is generated that is associated with a service provider (e.g., of the service provider module 102) to a political campaign to encourage support by the follower 106 to a candidacy of the admired party to a government office.

FIG. 11 is a system view of a service provider module 1102 communicating with an admired party webpage 1112 and follower webpages 1122A-N through a network 1100, according to one embodiment. Particularly, FIG. 11 illustrates the network 1100, the service provider module 1102, a community module 1104, a global shopping cart module 1106, a content management module 1108, an inventory management module 1110, the admired party webpage 1112, a widget module 1114, a product widget 1116, a media widget 1118, an idea widget 1120, the follower webpages 1122A-N, a replica of product widget 1124 and a replica of media widget 1126, according to one embodiment.

The network 1100 may facilitate communication by linking the service provider module 1102 with the admired party webpage 1112 and the follower webpages 1122A-N. The service provider module 1102 may provide web widgets (e.g., the web widgets may be graphical user interface elements that hold content and/or permits users to select from a number of options) to the admired party webpage 1112 and the follower webpages 1122A-N. The community module 1104 may link an admired party node to a follower node using the web widgets.

The global shopping cart module 1106 may keep track of transactions between the admired party node and one or more follower nodes. For example, the followers may be friends, fan, well wishers, patrons, and/or supporters who have an empathy relationship formed by a charismatic influence with the admired party and/or who may wish to import and/or purchase certain offerings in the admired party webpage 1112 to the webpages 1122A-N. The content management module 1108 may enable the admired party node to control (e.g., change content, upload content, manage content, etc.) content data associated with the admired party webpage 1112. For example, the content data may be audio data, video data, music data, visual data, etc.

The inventory management module 1110 may process, monitor and/or deliver reports of inventory data (e.g., associated with the web widgets) communicated between the admired party node and the follower nodes. The admired party webpage 1112 may be a webpage which integrates and/or displays the web widgets from the service provider module 1102. The widget module 1114 may generate the web widgets (e.g., the product widget 1116, media widget 1118, the idea widget 1120 of FIG. 11) which enable the service provider module 1102 to link with the admired party webpage 1112 and the follower webpages 1122A-N. The product widget 1116 may generate listings of various products (e.g., T-shirts, CDs, DVDs, video games, etc.) provided by the service provider module 1102. The media widget 1118 may provide listings associated with music, movies, and/or audio clips (e.g., displayed in the admired party webpage 1112). The idea widget 1120 may generate listings related to thoughts, reflections, concepts, and/or opinions (e.g., integrated into the follower webpages 1122A-N).

The follower webpages 1122A-N may be webpages that display replica of web widgets that are imported from the admired party webpage 1112 by followers. The replica of product widget 1124 may refer to a product widget 1116 imported by the followers from the admired party webpage 1112 listing same products. The replica of media widget 1126 may refer to any media widget integrated to the follower webpage 1122A-N.

In the example embodiment illustrated in FIG. 11, the service provider module 1102 communicates with the admired party webpage 1112 and the follower webpages 1122A-N through the network 1100. The service provider module 1102 consists of the community module 1104, the global shopping cart module 1106, the content management module 1108 and the inventory management module 1110. The admired party webpage 1112 displays the widget module 1114 which consists of the product widget 1116, media widget 1118, and the idea widget 1120. The replica of product widget 1124 and the replica of media widget 1126 are integrated into the follower webpages 1122A-N from the admired party webpage 1112.

The admired party node registered with the service provider module 1102 may integrate web widget provided by the service provider module 1102. The follower node (e.g., the follower node may purchase an offering of the web widget of the admired party node based on an empathy relationship between the admired party node and the follower node formed by a charismatic influence of the admired party node on the follower node) registered with the service provider module 1102 may import the web widget to a webpage (e.g., the follower webpages 1122A-N of FIG. 11) of the follower node.

The community module 1104 of the service provider module 1102 may link the admired party node and the follower node using the web widget. The global shopping cart module 1106 of the service provider module 1102 may track individual transactions of the follower node across the web widget of the admired party node and/or the web widget on the follower node to enable the follower node to checkout at any point in time when the follower node is logged on with the service provider module 1102. The content management module 1108 of the service provider module 1102 may enable the admired party node to control content data published on the admired party node.

The inventory management module 1110 of the service provider module 1102 may process the inventory data (e.g., the data associated with the web widgets) communicated between the admired party node and the follower node. The admired party webpage 1112 of the admired party may be linked with the follower webpage (e.g., the follower webpages 1122A-N of FIG. 11) of the follower of the admired party when the replica of the web widget (e.g., the web widget may include the product widget 1116, the media widget 1118, and the idea widget 1120) of the admired party webpage 1112 is integrated to the follower webpage. The follower may purchase an offering of the web widget of the admired party webpage 1112 and/or the replica of the web widget (e.g., the replica web widget may include the replica of product widget 1124, the replica of media widget 1126) on the follower webpage 1122A-N based on an empathy relationship between the admired party and the follower formed by a charismatic influence of the admired party on the follower.

A common module identification may be assigned to the web widget of the admired party webpage 1112 and/or to the replica of the web widget on the follower webpage. The admired party webpage 1112 and the follower webpage 1122 may be simultaneously updated (e.g., updating may be performed through an asynchronous communication and/or a synchronous communication among the service provider module 1102, the admired party webpage 1112, and the follower webpage 1122) using the common module identification based on data processed in the web widget (e.g., the product widget 1116, the media widget 1118, and/or the idea widget 1120) of the admired party webpage 1112 and the replica of the web widget (e.g., the replica of product widget 1124, and the replica of media widget 1126) on the follower webpage (e.g., the follower webpages 1122A-N of FIG. 11).

A social network may be formed between the admired party and the follower of the admired party based on an invitation data generated by the admired party webpage 1112 and/or the follower webpage 1122. Advertisement data may be rendered to the admired party webpage 1112 and/or the follower webpage 1122. The admired party may be enabled to render the advertisement data to the follower webpage (e.g., the follower webpages 1122A-N of FIG. 11). The web widget may be installed to the admired party webpage 1112 of an admired party through integrating a code of the web widget to the admired party webpage 1112 of the admired party. The web widget of the admired party webpage 1112 may be linked with a replica of the web widget of the admired party webpage 1112 imported to the follower webpage 1122A-N of a follower of the admired party.

The web widget (e.g., the product widget 1116, the media widget 1118, and/or the idea widget 1120) of the admired party webpage 1112 and/or the replica of the web widget on the follower webpage 1122A-N may be globally updated based on transaction data of the web widget of the admired party webpage 1112 and/or the follower webpage 1122A-N. The follower may import the replica of the web widget of the admired party webpage 1112 to the follower webpage 1122A-N to patronize an admired party. The follower may be assigned to a secondary status as the admired party when a web widget created by the follower is imported to a webpage of another follower patronizing the follower.

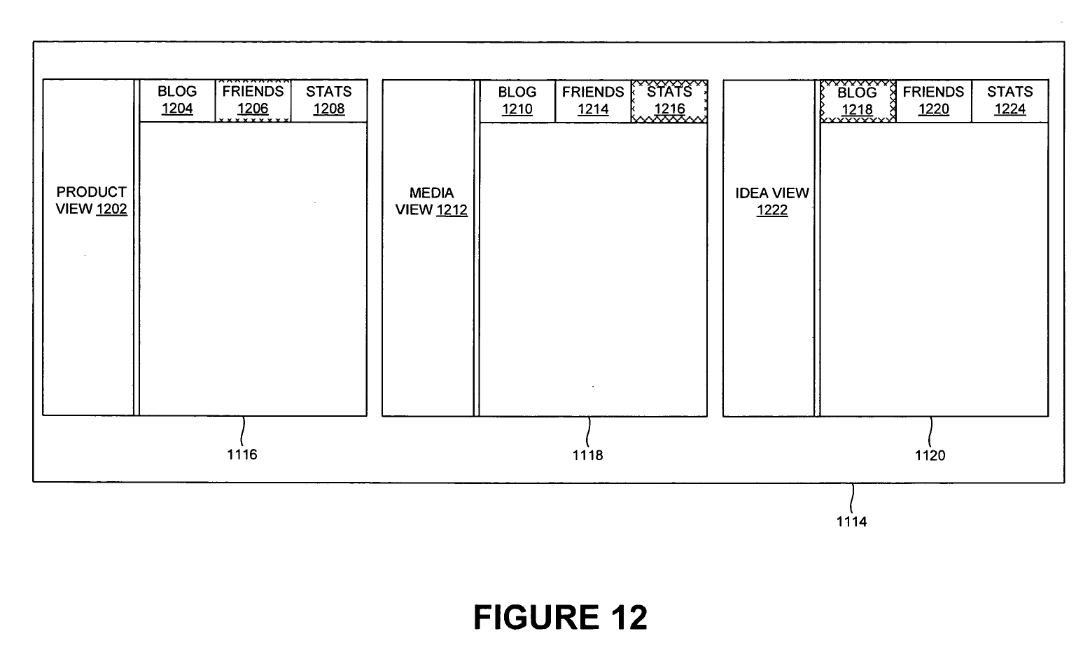

FIG. 12 is an exploded view of the widget module 1114 of FIG. 1, according to one embodiment. Particularly, FIG. 12 illustrates the product widget 1116, the media widget 1118, the idea widget 1120, a product view 1202, a blog link 1204, a friends link 1206, a stats link 1208, a media view 1212, a blog link 1210, a friends link 1214, a stats link 1216, an idea view 1222, a blog link 1218, a friends link 1220 and a stats link 1224, according to one embodiment.

The product view 1202 may display various products listed in the product widget 1116 of the admired party and/or the replica of the product widget 1124 in the follower webpage 1122A-N. The blog link 1204 may enable the users to express views and/or rate the various product of the product widget 1116. The friends link 1206 may display a list of followers (e.g., friends, fans, well wishers, patrons, supporters, etc.) who imports the product widget 1116 from the admired party webpage 1112 to the follower webpage 1122A-N.

The stats link 1208 may display collection, analysis, interpretation, explanation, and/or presentation of data associated with the product widget 1116. The media view 1212 may display various media content (e.g., video, audio, pictures, etc.) in the media widget 1118 which are imported to the follower webpages 1122A-N. The blog link 1210 may enable the users to express views and/or rate various playlist of the media widget 1118. The friends link 1214 may display a list of followers (e.g., friends, fans, well wishers, patrons, supporters, etc.) who imports media widget 1118 from the admired party webpage 1112 to the follower webpages 1122A-N. The stats link 1216 may display collection, analysis, interpretation, explanation, and/or presentation of data associated with the media widget 1118.

The idea view 1222 may display an opinion of a visual aspect of a figure, an image, and/or a symbol of the admired party. The blog link 1218 may enable the users to express views and/or rate opinions about ideas displayed in the idea widget 1120. The friends link 1220 may display a list of followers (e.g., friends, fans, well wishers, patrons, supporters, etc.) who imports the idea widget 1120 from the admired party webpage 1112 to the follower webpages 1122A-N. The stats link 1224 may display collection, analysis, interpretation, explanation, and/or presentation of data associated with the idea widget 1120.

In the example embodiment illustrated in FIG. 12, the exploded view of the widget module 1114 displays the product widget 1116, the media widget 1118 and the idea widget 1120. The product view 1202 associated with the product widget 1116 consists of the blog link 1204, the friends link 1206 and the stats link 1208. The media view 1212 associated with the media widget 1118 displays of the blog link 1210 the friends link 1214 and the stats link 1216. The exploded view of the web widget also displays the idea view 1222 associated with the idea widget 1120 that includes the blog link 1218, the friends link 1220 and the stats link 1224.

An individual blog (e.g., the blog link 1204, 1210 or 1218) may be rendered to comment on the product widget (e.g., the product widget 1116 of FIG. 11), the media widget (e.g., the media widget 1118 of FIG. 11), and/or the idea widget (e.g., the idea widget 1120 of FIG. 11). The admired party may solicit information from the follower in context of the product widget 1116, the media widget 1118 and/or the idea widget 1120. The product widget 1116 may include offering of T-shirts, CDs, DVDs, video games, and/or classified listings. The media widget 1118 may include offering of streaming audios, photographs, and/or streaming videos. In addition, the idea widget 1120 may include questions, surveys, proposals, hypotheses, and/or campaigns.

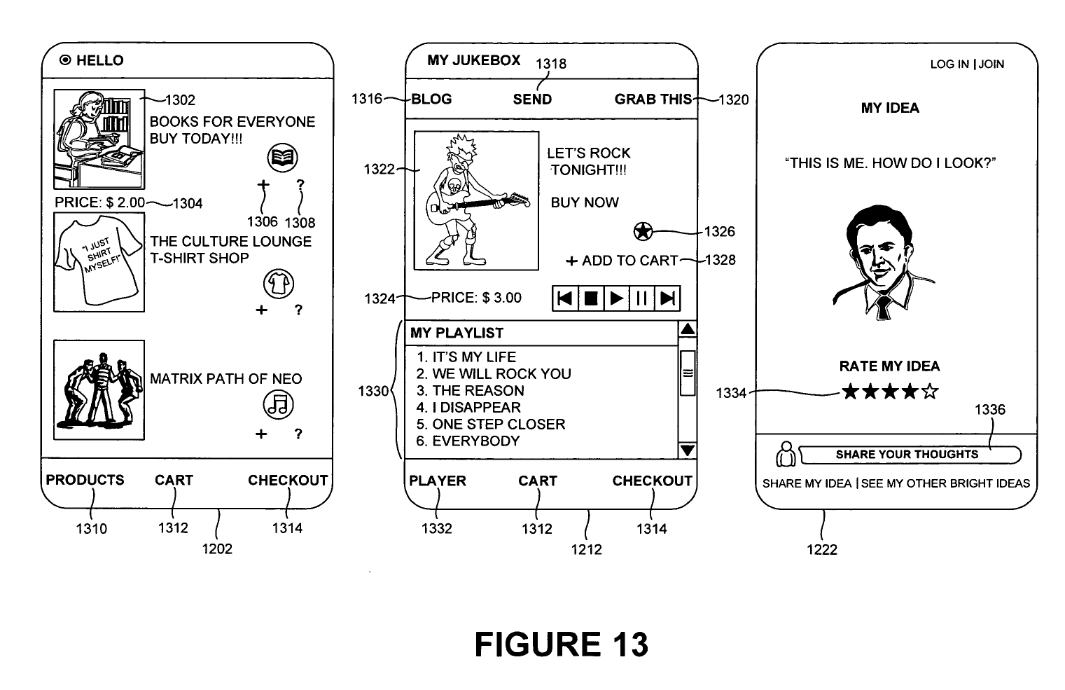

FIG. 13 is a user interface view of the web widget illustrating the product view 1202, the media view 1212 and the idea view 1222, according to one embodiment. Particularly, FIG. 13 illustrates a product ad 1302, a price tag 1304, an add check box 1306, a help option 1308, products option 1310, a cart option 1312, a checkout option 1314, a blog link 1316, a send option 1318, a grab this option 1320, a media ad 1322, a price tag 1324, a rate option 1326, an add to cart option 1328, a playlist 1330, a player link 1332, a rate my idea option 1334 and a share your thoughts option 1336, according to one embodiment.

The product ad 1302 may display the various products (e.g., T-shirts, books, CDs, DVDs, video games, etc.) available in the product widget 1116. The price tag 1304 may indicate value (e.g., selling price) of the products listed in the product widget 1116. The add check box 1306 may enable users to add selected products to user cart. The help option 1308 may aid and/or assist visitors of the admired party webpage 1112 and the follower webpages 1122A-N to select the desired web widgets. The products option 1310 may display a list of products available for the users to select and/or purchase desired product widgets. The cart option 1312 may be an option in markup page (e.g., website, blog, etc.) of the admired party (e.g., person, personal, representative of a non-human entity, etc.) through which the follower party purchase offerings associated with the web widgets (e.g., product widgets, media widgets, idea widgets, etc.) using shoppers cart from multiple admired parties.

The checkout option 1314 may enable follower to checkout at any point in time, when the follower is logged on with the service provider module 1102. The blog link 1316 may enable the users to express views and/or rate various playlist (e.g., the playlist 1330) in a jukebox associated with the media widget 1118. The send option 1318 may enable the users to import the selected song(s) from the playlist 1330 to the webpages 1122. The grab this option 1320 may enable the users to select desired songs from the playlist 1330 and/or replicate the songs to the webpages (e.g., the follower webpages 1122A-N of FIG. 1). The media ad 1322 may be graphical representation in the web widget to promote an item displayed in the playlist 1330.

The price tag 1324 may indicate a value (e.g., selling price) of the media widgets (e.g., video clips, audio clip, etc.) listed in the admired party webpage. The rate option 1326 may enable the users to rate any albums in the playlist 1330 of the jukebox. The add to cart option 1328 may enable the users to add selected songs and/or albums to the user cart. The playlist 1330 may display a list of songs available in the jukebox. The player link 1332 may enable the users to listen to the songs and/or albums displayed in the playlist 1330 (e.g., prior to selecting, importing and/or replicating the songs to the webpages 1122A-N). The rate my idea option 1334 may facilitate the users (e.g., followers, friends, etc.) to rate the ideas (e.g., thoughts, explanations, etc.) in the blogs associated with the admired party. The share your thoughts option 1336 may enable the users to express views and/or opinions about the contents in the idea widget 1222.

In example embodiment illustrated in FIG. 13, the user interface view displays the product view 1202, the media view 1212 and the idea view 1222. The product view 1202 displays various products along with price tags 1304 and 1324 and/or enable the users to select and/or import desired items to the webpages (e.g., the follower webpages 1122A-N of FIG. 1). The media view 1212 displays the playlist 1330 containing various songs and/or albums from which the users select and/or add to their cart using the add to cart option 1328. The idea view 1222 displays ratings of the ideas associated with the admired party. The users may also share views and/or ideas associated with the contents in the admired party webpage 1112 through share your thoughts option 1332.

The follower may be enabled to rate any item on the web widget of the admired party webpage 1122. A result of the rate any item may be centrally aggregated to render to the admired party webpage 1112. The individual transactions of the follower may be aggregated across the web widget of the admired party and/or the replica of web widget on the follower webpage (e.g., the follower webpages 1122A-N of FIG. 11) to enable the follower to checkout (e.g., using the checkout option 1314 of FIG. 13) at any point in time, when the follower is logged on with the service provider module 1102.

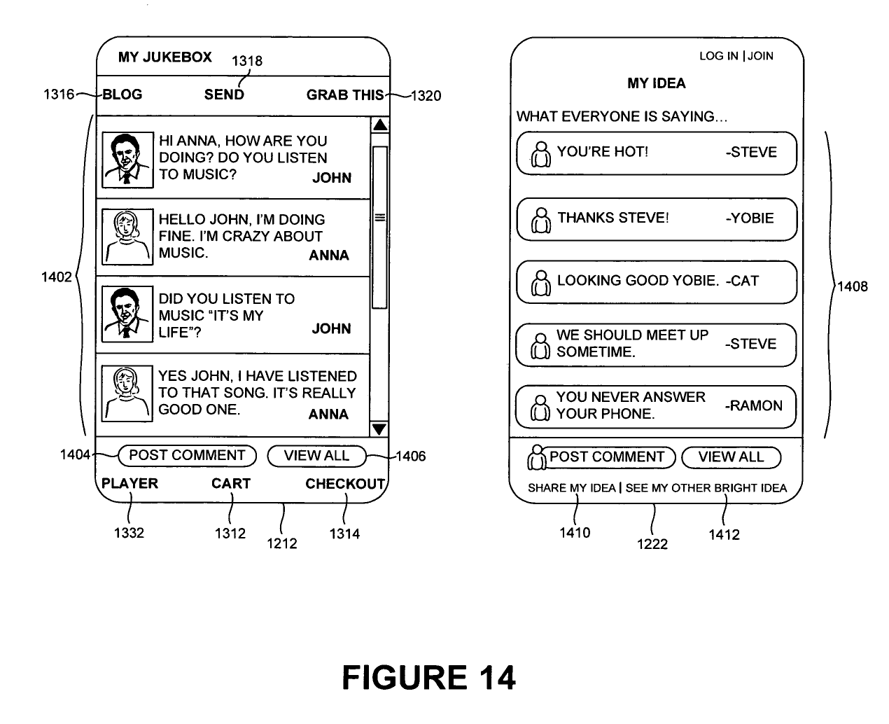

FIG. 14 is a user interface view of the media widget 1118 and the idea widget 1120 illustrating blogs, according to one embodiment. Particularly, FIG. 14 illustrates the cart option 1312, the checkout option 1314, the blog link 1316, the send option 1318, the grab this option 1320, the player link 1332, comments 1402, a post comment option 1404, a view all option 1406, comments 1408, a share my idea option 1410 and a see my another bright idea option 1412, according to one embodiment.

The comments 1402 may be messages uploaded in blogs created by individuals (e.g., followers, friends, etc) to express opinion(s) about the various playlist(s) 1330 available in the jukebox. The post comment option 1404 may be an option available for individuals to click and/or add comments in a blog list of the media view 1212 associated with the media widget 1118 of the admired party webpage 1112. The view all option 1406 may display all the comments uploaded in the blog by the individuals.

The comments 1408 may be messages uploaded in blog of the idea view 1222 by individuals (e.g., followers, friends, etc). The share my idea option 1410 may allow followers to share innovative ideas with other users (e.g., friends). The see my another bright idea option 1412 may enable the users (e.g., followers, friends, etc.) to view all the ideas displayed by the followers in the blog.

In the example embodiment illustrated in FIG. 14, the user interface view displays the blog of the media view 1212 associated with the media widget 1118. The media view 1212 displays the comments 1402 uploaded by the individuals and/or enables the admired party having the media widget 1118 to monitor consumption of songs in the playlist 1330. The interactive format may be placed on blogs allowing visitors to leave comments, opinion, feedback, etc. associated with ideas displayed in blogs.

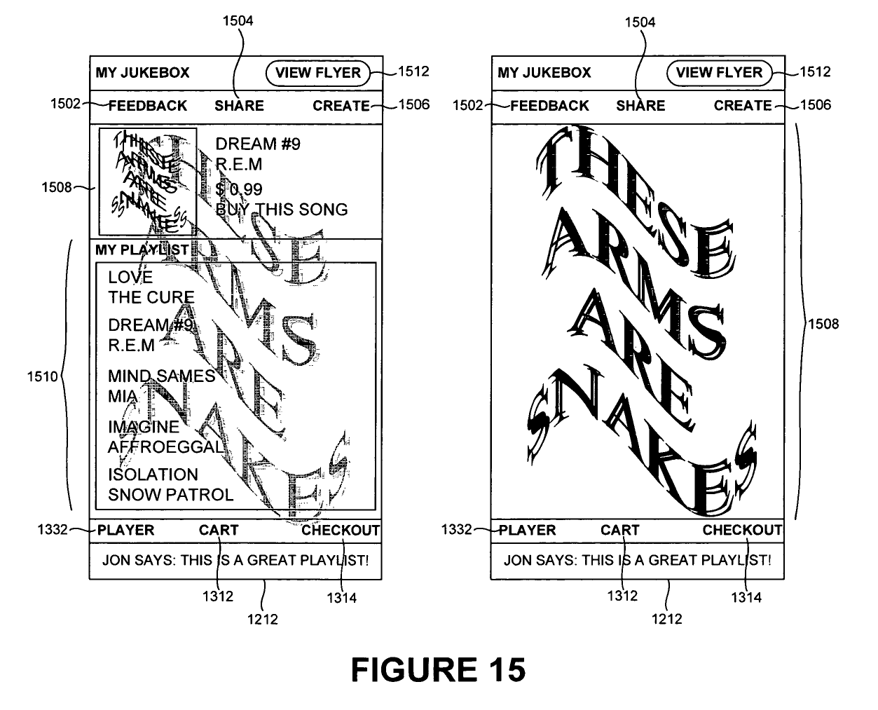

FIG. 15 is a user interface view displaying a promotional graphic data on the web widget, according to one embodiment. Particularly, FIG. 15 illustrates the cart option 1312, the checkout option 1314, the player option 1332, a feedback option 1502, a share option 1504, a create option 1506, a block 1508, a playlist 1510 and a view flyer option 1512, according to one embodiment.

The feedback option 1502 may enable users to provide feedback, comments, thoughts and/or opinions about media associated with the media widget 1118 available in a jukebox. The share option 1504 may enable the users to share thoughts, ideas, and/or files (e.g., audio, video, visual data, etc.) in an interactive format in blogs of the jukebox. The create option 1506 may enable the users to create and/or add songs, and/or files to the playlist 1510 in the jukebox. The block 1508 may display (e.g., in the background and/or in the foreground) the promotional graphic data associated with the web widget (e.g., an item, media, etc.) from the playlist 1510. The playlist 1510 may display a list of songs, such that the users select desired songs from the list of songs. The view flyer option 1512 may enable the users to view advertisements, and/or layouts associated with the jukebox.

In the example embodiment illustrated in FIG. 15, the user interface view illustrates the playlist 1510 from which the users select, purchase and/or integrate songs, albums into webpages (e.g., the admired party webpage 1112, the follower party webpages 1122A-N). The users may add selected items from the list to a cart (e.g., using the global shopping cart module 1106). The users interface view may also enable the users rate, and/or post comments associated with the jukebox using the feedback option 1502. The user interface view also displays events of live concerts of artists associated with the songs in the playlist 1510.

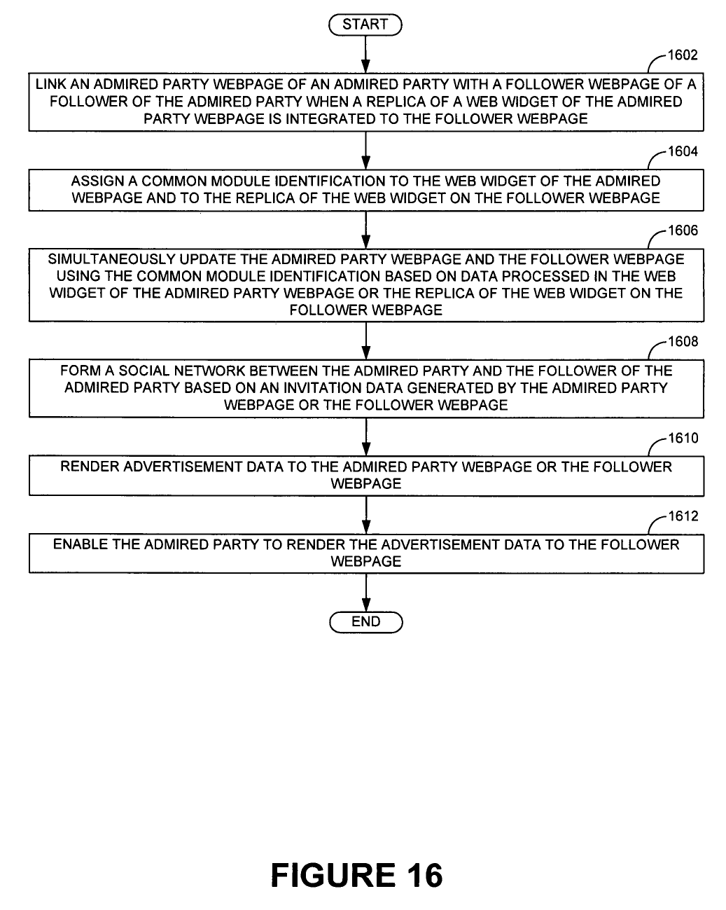

FIG. 16 is a process flow of forming a social network between an admired party and a follower of the admired party, according to one embodiment. In operation 1602, an admired party webpage (e.g., the admired party webpage 1112 of FIG. 1) of the admired party may be linked with a follower webpage (e.g., the follower webpages 1122A-N of FIG. 1) of the follower of the admired party when a replica of a web widget of the admired party webpage 1112 is integrated to the follower webpage 1122A. In operation 1604, a common module identification may be assigned to the web widgets 1116-1120 of the admired party webpage 1112 and/or to the replica of the web widget 1124-1126 on the follower webpage 1122A-N.

In operation 1606, the admired party webpage 1112 and the follower webpage 1122A may be updated simultaneously (e.g., using the common module identification) based on data processed in the web widgets 1116-1120 of the admired party webpage 1112 and/or the replica of the web widget 1124-1126 on the follower webpage 1122A-N.

In operation 1608, a social network between the admired party and the follower of the admired party may be formed (e.g., through community network module 1104 of FIG. 11) based on an invitation data generated by the admired party webpage 1112 or the follower webpage (e.g., the follower webpages 1122A-N of FIG. 11). In operation 1610, advertisement data may be rendered to the admired party webpage 1112 and/or the follower webpage 1122A-N. In operation 1612, the admired party may be enabled to render the advertisement data to the follower webpage 1122A-N.

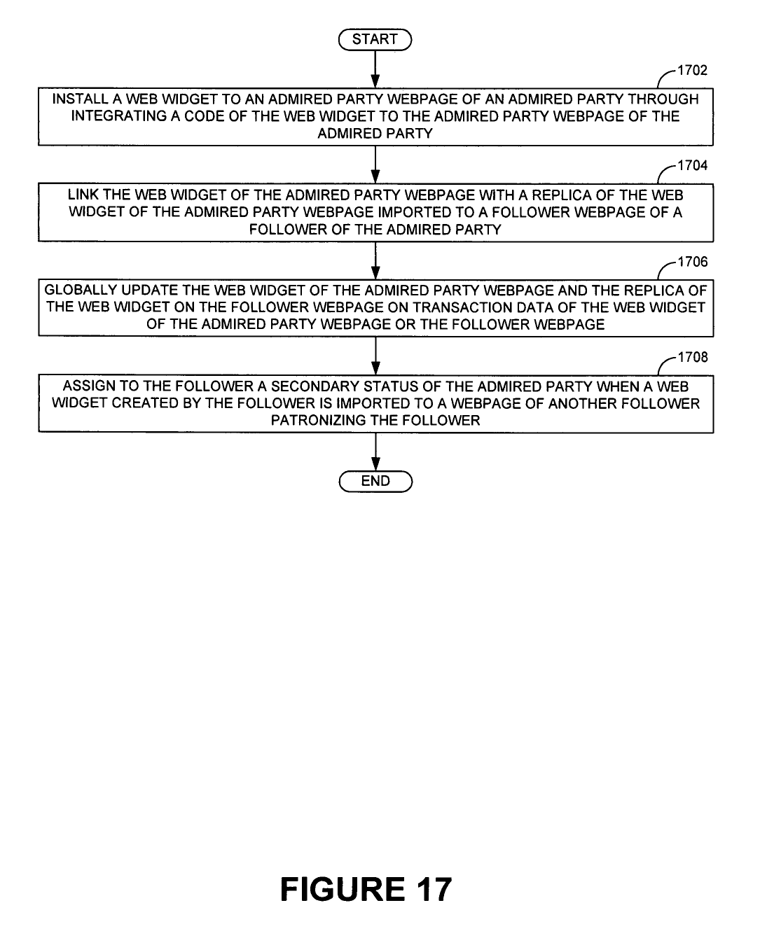

FIG. 17 is a process flow of globally updating the web widget of the admired party webpage and the replica of the web widget on the follower webpage, according to one embodiment. In operation 1702, a web widget may be installed to an admired party webpage (e.g., the admired party webpage 1112 of FIG. 11) of the admired party through integrating a code of the web widget 1116-1120 to the admired party webpage 1112 of the admired party. In operation 1704, the web widget of the admired party webpage 1112 may be linked (e.g., using the service provider module 1102) with a replica of the web widget of the admired party webpage 1112 imported to a follower webpage (e.g., the follower webpages 1122A-N of FIG. 11) of the follower of the admired party.

In operation 1706, the web widget 1116 of the admired party webpage 1112 and the replica of the web widget 1124 may be updated globally on the follower webpage 1122A-N on transaction data of the web widget of the admired party webpage 1112 and/or the follower webpage (e.g., the follower webpages 1122A-N of FIG. 11). In operation 1708, a secondary status of the admired party may be assigned to the follower when a web widget created by the follower is imported to a webpage of another follower patronizing the follower.

Although the present embodiments have been described with reference to specific example embodiments, it will be evident that various modifications and changes may be made to these embodiments without departing from the broader spirit and scope of the various embodiments.

For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or Digital Signal Processor (DSP) circuitry). For example, the service provider module 1102, the community module 1104, the global shopping cart module 1106, the content management module 1108, the inventory management module 1110, the widget module 1114 and other modules of FIGS. 1-17 may be enabled using a service provider circuit, a community circuit, a global shopping cart circuit, a content management circuit, a inventory management circuit, a widget circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a service provider module, comprising:
linking an admired party webpage of an admired party with a follower webpage of a follower of the admired party when a replica of a web widget of the admired party webpage is integrated to the follower webpage;
assigning a common module identification to the web widget of the admired party webpage and to the replica of the web widget on the follower webpage; and
simultaneously updating the admired party webpage and the follower webpage using the common module identification based on data processed in at least one of the web widget of the admired party webpage and the replica of the web widget on the follower webpage,
wherein the follower purchases an offering of the at least one of the web widget of the admired party webpage and the replica of the web widget on the follower webpage based on an empathy relationship between the admired party and the follower formed by a charismatic influence of the admired party on the follower.

2. The method of claim 1, wherein the simultaneously updating is performed through at least one of an asynchronous communication and a synchronous communication among the service provider module, the admired party webpage, and the follower webpage.

3. The method of claim 1, further comprising forming a social network between the admired party and the follower of the admired party based on an invitation data generated by at least one of the admired party webpage and the follower webpage.

4. The method of claim 1, wherein the web widget to include at least one of a product widget, a media widget, and an idea widget.

5. The method of claim 4, further comprising rendering an individual blog to comment on the at least one of the product widget, the media widget and the idea widget, wherein the admired party to solicit information from the follower in context of the product widget, the media widget and the idea widget.

6. The method of claim 5, further comprising enabling the follower to rate any item on the web widget of the admired party webpage, wherein a result of the rate any item is centrally aggregated to render to the admired party webpage.

7. The method of claim 1, further comprising embedding at least one of a promotional graphic data and a really simple syndication (RSS) feed to the web widget when the at least one of the promotional graphic data and the RSS feed is thematically relevant to the at least one of the web widget.

8. The method of claim 7, wherein the at least one of the promotional graphic data and the RSS feed is placed to at least one of a foreground and a background of the web widget.

9. The method of claim 8, further comprising aggregating individual transactions of the follower across the web widget of the admired party and the replica web widget on the follower webpage to enable the follower to checkout at any point in time when the follower is logged on with the service provider module.

10. The method of claim 9, further comprising rendering advertisement data to at least one of the admired party webpage and the follower webpage.

11. The method of claim 10, further comprising enabling the admired party to render the advertisement data to the follower webpage.

12. The method of claim 1 in a form of a machine-readable medium embodying a set of instructions that, when executed by a machine, causes the machine to perform the method of claim 1.

13. A method of an admired party module, comprising:
installing a web widget to an admired party webpage of an admired party through integrating a code of the web widget to the admired party webpage of the admired party;
linking the web widget of the admired party webpage with a replica of the web widget of the admired party webpage imported to a follower webpage of a follower of the admired party; and
globally updating the web widget of the admired party webpage and the replica of the web widget on the follower webpage based on transaction data of at least one of the web widget of the admired party webpage and the follower webpage,
wherein the follower to import the replica of the web widget of the admired party webpage to the follower webpage to patronize the admired party.

14. The method of claim 13, wherein the at least one of the web widget of the admired party webpage and the replica of the web widget of the admired party webpage on the follower webpage to include at least one of a product widget, a media widget, and an idea widget.

15. The method of claim 14, wherein the product widget to include at least one offering of T-shirts, CDs, DVDs, video games, and classified listings, the media widget to include at least one offering of streaming audios, photographs, and streaming videos, and the idea widget to include at least one of questions, surveys, proposals, theses, and campaigns.

16. The method of claim 13, further comprising assigning the follower to a secondary status as the admired party when a web widget created by the follower is imported to a webpage of another follower patronizing the follower.

17. A system, comprising:
an admired party node registered with a service provider module to integrate a web widget provided by the service provider module;
a follower node registered with the service provider module to import the web widget to a webpage of the follower node; and
a community module of the service provider module to link the admired party node and the follower node using the web widget,
wherein the follower node purchases an offering of the web widget of the admired party node based on an empathy relationship between the admired party node and the follower node formed by a charismatic influence of the admired party node on the follower node.

18. The system of claim 17, further comprising a global shopping cart module of the service provider module to track individual transactions of the follower node across the web widget of the admired party node and the web widget on the follower node to enable the follower node to checkout at any point in time when the follower node is logged on with the service provider module.

19. The system of claim 18, further comprising a content management module of the service provider module to enable the admired party node to control content data published on the admired party node.

20. The system of claim 19, further comprising an inventory management module of the service provider module to process inventory data communicated between the admired party node and the follower node.
